(19) United States
(12) Patent Application Publication
(10) Pub. No.: US 2009/0139598 A1
(43) Pub. Date: Jun. 4, 2009

(54) COVER ASSEMBLY

(75) Inventors: Dave Abare, Haverhill, MA (US); Jeffrey P. Osgood, Haverhill, MA (US); Mark McIntyre, Litchfield, CT (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: New England Die Cutting, Inc., Haverhill, MA (US)

(21) Appl. No.: 11/947,107

(22) Filed: Nov. 29, 2007

(51) Int. Cl. B65D 59/06; F16L 57/00

(52) U.S. Cl. 138/96 R; 220/796; 29/592; 138/89.4

(57) ABSTRACT

A system, method, and device for an assembly cover positioning on an end piece is disclosed. The exemplary device may have a sidewall portion made of a ring of material with an aperture in the center wherein the aperture is sized to produce a frictional fit on the end piece. The exemplary device also has a cover portion coupled to a top portion of the sidewall portion.

### TECHNICAL FIELD

The present invention relates to assembly covers and more particularly, relates to a flexible assembly cover and method of manufacturing.

### BACKGROUND INFORMATION

Assembly covers may be used to protect pipes and thread ends, as well as other end pieces. The assembly cover may be made of molded plastic or rubber. A mold of the assembly cover is first produced and is specifically designed to produce an assembly cover with an exact design and dimensions. The mold may only be used to produce a single specific design of assembly cover. Molten plastic or rubber is injected into the mold and cooled. The hardened assembly cover is removed from the mold and may receive additional processing to produce a final molded assembly cover.

In order to recoup costs for producing a mold and utilize mold injection equipment, molded assembly covers may need to be ordered in large quantities. Many pieces of equipment that may be produced in limited quantity may require a limited number of assembly covers in a variety of sizes. In addition, the molding process requires additional time to produce the desired mold. Accordingly, a need exists for a device, method, and system that allows for quick and efficient production of assembly covers. The device, method and system may allow for the production of limited quantities in a variety of designs. In addition the assembly cover may need to have a sturdy and rigid design. The method of manufacturing assembly covers may benefit from not requiring the use of a mold and the additional costs of a mold.

### SUMMARY

The present invention is a novel device, system, and method for an assembly cover for protecting a work piece. An exemplary embodiment, according to the present invention, may provide a method of producing the assembly cover which involves cutting a side wall portion from a sheet of material. An aperture may be cut into the side wall portion. A cover portion may also be cut from a sheet of material. The cover portion may be coupled to a top of the side wall portion.

Alternate embodiments may include one or more of the following. According to one embodiment, the sheet of material is rubber. The coupling may involve vulcanizing the cover portion to the side wall portion. In another embodiment, the cover portion includes a lanyard with an aperture sized to receive the work piece. In yet another embodiment the actions of cutting are accomplished with laser cutting, die cutting, waterjet cutting, or a lathe. It is important to note that the present invention is not intended to be limited to a system or method which must satisfy one or more of any stated objects or features of the invention. It is also important to note that the present invention is not limited to the exemplary embodiments described herein. Modifications and substitutions by one of ordinary skill in the art are considered to be within the scope of the present invention, which is not to be limited except by the claims stated later herein.

### BRIEF DESCRIPTION OF THE DRAWINGS

These and other features and advantages of the present invention will be better understood by reading the following detailed description, taken together with the drawings wherein:

FIG. 1A is a perspective view of an assembly cover according to a first exemplary embodiment of the invention.

FIG. 1B is a side profile view of an assembly cover according to the first exemplary embodiment of the invention.

FIG. 2A is a perspective view of an assembly cover according to a second exemplary embodiment of the invention.

FIG. 2B is a side profile view of an assembly cover according to the second exemplary embodiment of the invention.

FIG. 3 is a flowchart of a method of producing an assembly cover according to an exemplary embodiment of the invention.

### DETAILED DESCRIPTION

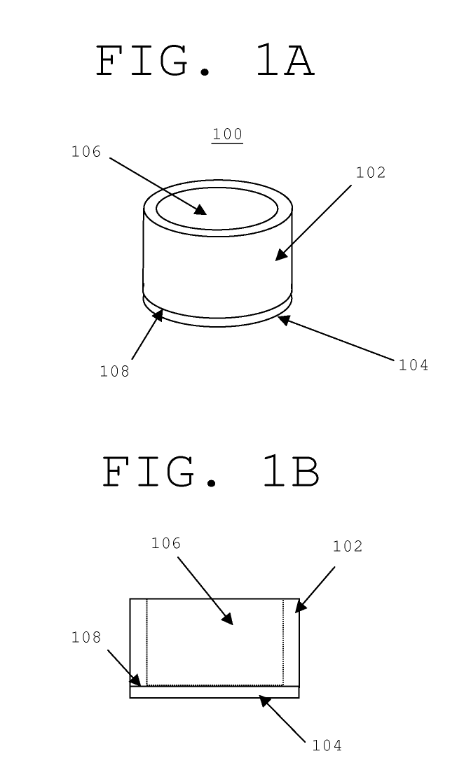

Referring to FIGS. 1A and 1B, a first exemplary embodiment of an assembly cover 100 is shown. The assembly cover 100 has a sidewall portion 102 and a cover portion 104. The sidewall portion 102 has an aperture 106 for receive a work piece (not shown). The assembly cover 100 is pushed onto the work piece. The sidewall portion 102 surrounds the work piece and may produce a frictional fit with the inner surface of the sidewall portion 102. The sidewall portion 102 and cover portion 104 protect the work piece from accidental contact, dirt, and moisture.

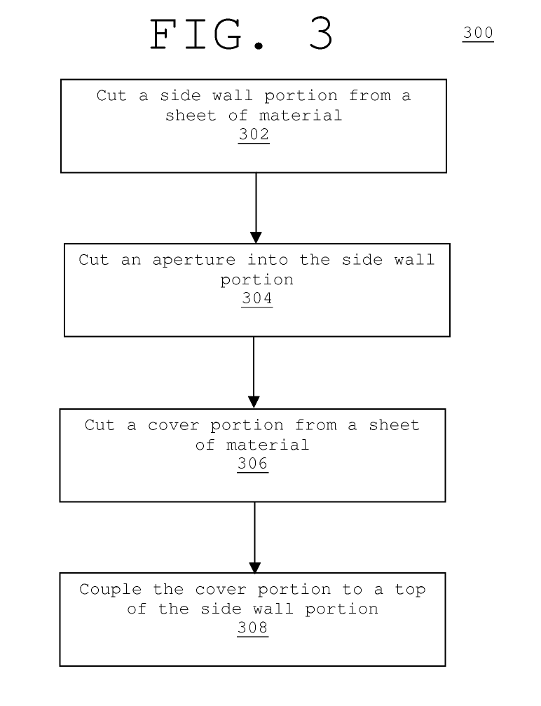

The cover portion 104 is coupled to the sidewall portion 102 by coupling 108. Coupling 108 may use a variety of coupling methods for example, adhesive, epoxy, vulcanization, or other coupling methods. The construction of the assembled cover is discussed in greater detail later herein with reference to FIG. 3. The aperture 106 may be sized based on the size of the work piece. Additionally, the thickness of the sidewall portion 102 and cover portion 104 may also be sized based on the amount of desired protection. For example, thicker walls and cover may be used to cushion and/or insulate the work piece from the outside environment. A variety of thicknesses may be used.

The overall size and shape of the assembly cover 100 may be based on the work piece. For example, the depth and the width of the aperture 106 may be specifically designed for each work piece. The tolerance used to produce a frictional fit between the assembly cover 100 and work piece may also be selected based on the intended use of the assembly cover 100. For example, work pieces that may not be accessed often may require a tighter frictional fit to prevent accidental removal of the assembly cover 100 whereas work pieces that may be accessed often may require a lesser frictional fit to allow easy removal by hand. The size and shape may also be designed based on the material used to construct the assembly cover 100. For example, more rigid material may require less of a frictional fit.

The shape of the sidewall portion 102, cover portion 104, and aperture 106 may be a variety of shapes depending on the desired application. The sidewall portion 102, cover portion 104, and aperture 106 are not limited to the cylindrical shape of the exemplary embodiment. For example, the aperture 106 may be whatever the shape of the work piece. A square or rectangular shaped aperture 106 may be used for an electrical conductor or other work piece that is square or rectangular shaped. In addition, the aperture 106 may have a different shape than the sidewall portion 102. For example, the aperture may be a cylindrical shape and the sidewall portion may be a square profile sized larger than the cylindrical aperture. The cap portion 104 may have the same or different shape as the sidewall profile 102.

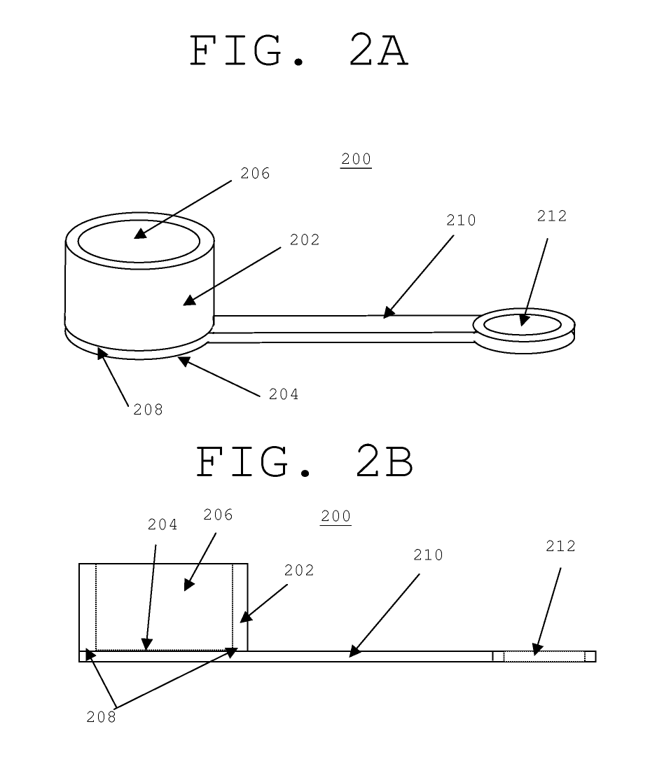

Referring to FIGS. 2A and 2B, the assembly cover 200 of the second exemplary embodiment has similar components as the assembly cover 100 of the first exemplary embodiment. For example, a sidewall portion 202, an aperture 206, and a coupling 208 of the second exemplary embodiment may be similar or the same as previously described with regard to the first exemplary embodiment. In addition, the cover portion may include a lanyard 210 and an attachment portion 212. The lanyard 210 and an attachment portion 212 may be made of the same material as the cover portion 204. The attachment portion 212 may be a loop designed to fit around the work piece to allow the assembly cover 200 to remain coupled to the work piece even when the work piece is not housed within the aperture 106. The attachment portion may be a variety of sizes and shapes and may be designed to also provide a frictional fit around the work piece. The lanyard 210 may also be a variety of sizes and shapes depending on the desired use of the assembly cover 200.

Referring to FIG. 3, an exemplary method of construction 300 of the assembly cover 100, 200 is provided. The side wall portion 102, 202 may be cut from a sheet of material (block 302). The material may be a sheet of rubber or plastic. The method of cutting may use a variety of cutting methods, for example, stamp or punch, laser, die cutting, lathe, or a blast of liquid or particles to cut the material. An aperture 106, 206 may be cut into the sidewall portion 102, 202 (block 304). The depth of the sheet of material may determine the depth of the aperture 106, 206. It should be noted that the action of cutting the sidewall portion 102, 202 and aperture 106, 206 may be accomplished simultaneously or in sequence. A cover portion 104, 204 may be cut from a sheet of material (block 306). The thickness of the sheet of material may determine the thickness of the cover portion 104, 204. The method of cutting may use a variety of cutting methods as previously discussed. The cover portion 104, 204 may be coupled to a top of the sidewall portion 102, 202 (block 308). The coupling 108, 208 may use a variety of coupling methods for example, adhesive, epoxy, vulcanization, or other coupling method. The coupling method may be based on the material used to construct the sidewall portion 102, 202 and cover portion 104, 204. For example, vulcanization may require rubber material.

Other modifications and substitutions by one of ordinary skill in the art are considered to be within the scope of the present invention, which is not to be limited except by the following claims.

The invention claimed is:

1. An assembly cover for positioning on an end piece comprising:
a sidewall portion made of a ring of material with an aperture in the center wherein the aperture is sized to produce a frictional fit on the end piece; and
a cover portion coupled to a top portion of the side wall portion.

2. The assembly cover of claim 1, wherein the sidewall portion and cover portion are made from a sheet of material.

3. The assembly cover of claim 1, wherein coupling of the sidewall portion to the cover portion involves vulcanizing the cover portion to the sidewall portion.

4. The assembly cover of claim 1, wherein the cover portion includes a lanyard with an aperture sized to receive the end piece.

5. The assembly cover of claim 2, wherein the sheet of material is cut with a laser.

6. The assembly cover of claim 2, wherein the sheet of material is cut with one of a group consisting of: laser, waterjet cutting, die cutting, or lathe.

7. A method of producing an assembly cover comprising the acts of:
cutting a side wall portion from a sheet of material;
cutting an aperture into the side wall portion;
cutting a cover portion from a sheet of material; and
coupling the cover portion to a top of the side wall portion.

8. The method of claim 7, wherein the sheet of material is rubber.

9. The method of claim 8, the action of coupling involves vulcanizing the cover portion to the side wall portion.

10. The method of claim 7, wherein the cover portion includes a lanyard with an aperture sized to receive the work piece.

11. The method of claim 7, wherein the aperture is sized to produce a frictional fit on the end piece.

12. The method of claim 7, wherein the actions of cutting are accomplished with a laser.

13. The method of claim 7, wherein the actions of cutting are accomplished with one of a group consisting of: a laser, waterjet cutting, lathe or die cutting.

14. An assembly cover for positioning on an end piece comprising:
a sidewall portion made of a ring of rubber cut from a sheet of material with an aperture in the center wherein the aperture is sized to produce a frictional fit on the end piece; and
a cover portion made of rubber cut from a sheet of material coupled to a top portion of the sidewall portion by vulcanizing the cover portion to the sidewall portion wherein the cover portion includes a lanyard with an aperture sized to receive the end piece.

15. The assembly cover of claim 14, wherein the sheet of material is cut with a laser.

16. The assembly cover of claim 14, wherein the sheet of material is cut with one of a group consisting of: laser, waterjet cutting, die cutting, or lathe.
